(19) United States
(12) Patent Application Publication
(10) Pub. No.: US 2026/0012954 A1
(43) Pub. Date: Jan. 8, 2026

(54) SYSTEMS AND METHODS FOR 2-PORT PDCCH TRANSMISSION WITH DUAL-POLARIZED ANTENNAS

(71) Applicant: Huawei Technologies Co. ,Ltd., Shenzhen (CN)

(72) Inventors: Xi Zhang, Beijing (CN); Wen Tong, Ottawa (CA); Xiaoyan Bi, Shanghai (CN); Jianglei Ma, Ottawa (CA)

(21) Appl. No.: 19/180,701

(22) Filed: Apr. 16, 2025

Related U.S. Application Data
(63) Continuation of application No. PCT/CN2022/125917, filed on Oct. 18, 2022.

(51) Int. Cl. H04W 72/23; H04L 27/26

(52) U.S. Cl. CPC H04W 72/23; H04L 27/261

(57) ABSTRACT

Some aspects of the present description provide methods including: receiving an indication of an association between at least one physical downlink control channel (PDCCH) layer and at least one demodulation reference signal (DMRS) port from more than one available DMRS port, wherein each PDCCH layer of the at least one PDCCH layer comprises one or more search space set, or one or more search space set group, and each DMRS port is transmitted over one polarization direction; performing blind detection on the one or more search space sets or the one or more search space set groups on each PDCCH layer of the at least one PDCCH layer.

### CROSS REFERENCE

The present application is a continuation of International Application No. PCT/CN2022/125917, filed on Oct. 18, 2022, the disclosure of which is hereby incorporated by reference in its entirety.

### TECHNICAL FIELD

The present disclosure relates generally to wireless communications, and in particular to systems and methods for 2-port physical downlink control channel (PDCCH) transmission and reception with dual-polarized antennas.

### BACKGROUND

In Fifth Generation (5G) New Radio (NR), a synchronization signal-physical broadcast channel (SS-PBCH) block (SSB) is transmitted with one antenna port, i.e. antenna port p=4000 is used for transmission of primary synchronization signal (PSS), secondary synchronization signal (SSS), physical broadcast channel (PBCH) and demodulation reference signal (DM-RS) for PBCH. An antenna port is a virtual concept and is not necessarily equivalent to transmission on a given antenna. For example, a base station (BS) may use two antennas to transmit one antenna port. A user equipment (UE) may have no knowledge of antenna architecture at the base station or how such 1-port SSB is transmitted via one or more antennas at the base station.

At frequencies in the millimeter wave (mmWave) range (e.g., 26, 38, 39, 73 GHz) and the mid-band range (e.g., 3.5, 3.7, 4.7, 4.9 GHZ), dual-polarized antennas are widely used at the base station and the UE. With dual-polarized antennas, two linearly polarized antennas are often superposed on a same location, but separated by about 90 degrees in the polarization direction, for example, vertical and horizontal polarization directions or ±45 degree slant polarization directions. With dual-polarized antennas, independent signals can be transmitted from antennas with different polarization directions. There may be multiple antennas corresponding to the same polarization direction, for example, the first and second groups of antennas for vertical and horizontal polarization directions or ±45 degree slant polarization directions, respectively. In this case, one antenna over vertical or −45-degree slant polarization direction may be superposed with one antenna over horizontal or ±45-degree slant polarization direction. It is also possible that the first and second groups of antennas for vertical and horizontal polarization directions or ±45 degree slant polarization directions are located separately, e.g., the first group of antennas at one location and the second group of antennas at another location. In such cases, the number of antennas in the first and the second groups of antennas can be same or different.

When utilizing dual-polarized antennas to transmit and receive 1-port physical downlink control channel (PDCCH) and 1-port demodulation reference signal (DMRS) that is used to facilitate the reception of PDCCH in 5G NR, typically the same signal, including both 1-port PDCCH and 1-port DMRS, is transmitted from dual-polarized antennas at the base station. The manner of detection at the UE is left to UE implementation, such as by selecting or combining signals received on UE dual-polarized antennas. Such a transmission scheme provides robustness against changes in a wireless propagation channel and UE movement or rotation, or both, in a heuristic way.

There is a limitation of using 1-port PDCCH and 1-port DMRS with dual-polarized antennas. For example, the limitation is transmission capacity may be halved as compared to the maximum capability that is available with dual-polarized antennas at the base station and the UE, even when robustness is not a major concern

### SUMMARY

According to some aspects of the disclosure there is provided a method involving: receiving, by user equipment (UE), an indication of an association between at least one physical downlink control channel (PDCCH) layer and at least one demodulation reference signal (DMRS) port from more than one available DMRS port, wherein each PDCCH layer of the at least one PDCCH layer includes one or more search space set, or one or more search space set group, and each DMRS port is transmitted over one polarization direction, performing, by the UE, blind detection on the one or more search space set or the one or more search space set group on each PDCCH layer of the at least one PDCCH layer. When the method is implemented, doubled maximum PDCCH capacity could be achieved. Further, the method could enable flexible tradeoff among capacity/reliability exploiting dual-polarized antennas at BS and UE.

In some embodiments, performing blind detection involves performing blind detection on two search space sets or two search space set groups, each on a respective PDCCH layer, wherein each PDCCH layer is associated with one DMRS port.

In some embodiments, performing blind detection involves performing blind detection on two search space sets or two search space set groups, each on a respective PDCCH layer, wherein a first PDCCH layer is transmitted over a different polarization direction than the second PDCCH layer.

In some embodiments, performing blind detection involves performing blind detection on one search space set or one search space set group on one PDCCH layer, wherein the one PDCCH layer is associated with one DMRS port or is transmitted over a single polarization direction.

In some embodiments, the method further involves: receiving, by the UE, configuration information that two search space sets or two search space set groups are each associated with one PDCCH layer and one DMRS port; and receiving, by the UE, an indication that the UE is to perform blind detection for at least one of: a specific PDCCH layer; or a specific search space set or a specific search space set group of the one PDCCH layer.

In some embodiments, the method further involves: receiving, by the UE, configuration information that one PDCCH layer includes one search space set or one search space set group associated with a plurality of DMRS ports; and receiving, by the UE, an indication that the UE is to perform blind detection for one PDCCH layer including the one search space set or the one search space set group based on a particular DMRS port of the plurality of DMRS ports.

In some embodiments, performing blind detection involves performing blind detection on one search space set or one search space set group on one PDCCH layer, wherein the PDCCH layer is associated with a plurality of DMRS ports or is transmitted over a plurality of polarization directions.

In some embodiments, the method further involves: receiving, by the UE, configuration information that one search space set or one search space set group is associated with a plurality of DMRS ports; and receiving, by the UE, an indication that the UE is to perform blind detection for the one search space set or the one search space set group based on at least two DMRS ports of the plurality of DMRS ports.

In some embodiments, the method further involves performing interference mitigation, by the UE, by assuming that a second DMRS port or a second PDCCH layer is interference for a first DMRS port or a first PDCCH layer, respectively.

In some embodiments, the method further involves receiving, by the UE, configuration information for the UE to transmit per-DMRS-port signal-to-interference-plus-noise ratio (SINR) on a physical uplink control channel (PUCCH) or a physical uplink shared channel (PUSCH).

According to some aspects of the disclosure there is provided a device including a processor and a computer-readable storage media. The computer-readable storage media has stored thereon, computer executable instructions, that when executed by the processor, perform a method as described above or detailed below.

According to some aspects of the disclosure there is provided a method involving: transmitting, by a base station, an indication of an association between at least one physical downlink control channel (PDCCH) layer and at least one demodulation reference signal (DMRS) port from more than one available DMRS port, wherein each PDCCH layer of the at least one PDCCH layer includes one or more search space set or one or more search space set group, and each DMRS port is transmitted over one polarization direction.

In some embodiments, the indication includes an indication that two search space sets or two search space set groups are each on a respective PDCCH layer, wherein each PDCCH layer is associated with one DMRS port.

In some embodiments, the indication includes an indication that two search space sets or two search space set groups are each on a respective PDCCH layer, wherein a first PDCCH layer is transmitted over a different polarization direction than a second PDCCH layer.

In some embodiments, the indication includes an indication that one search space set or one search space set group is on one PDCCH layer, wherein the one PDCCH layer is associated with one DMRS port or is transmitted over a single polarization direction.

In some embodiments, the method further involves: transmitting, by the base station, configuration information that two search space sets or two search space set groups are each associated with one PDCCH layer and one DMRS port; and transmitting, by the base station, an indication that a user equipment (UE) is to perform blind detection for at least one of: a specific PDCCH layer; or a specific search space set or a specific search space set group of the two PDCCH layers.

In some embodiments, the method further involves: transmitting, by the base station, configuration information that one PDCCH layer includes one search space set or one search space set group associated with a plurality of DMRS ports; and transmitting, by the base station, an indication that a user equipment (UE) is to perform blind detection for one PDCCH layer including the one search space set or the one search space set group based on a particular DMRS port of the plurality of DMRS ports.

In some embodiments, the indication includes an indication that one search space set or one search space set group is on one PDCCH layer, wherein the PDCCH layer is associated with a plurality of DMRS ports or is transmitted over a plurality of polarization directions.

In some embodiments, the method further involves: transmitting, by the base station, configuration information that one search space set or one search space set group is associated with a plurality of DMRS ports; and transmitting, by the base station, an indication that a user equipment (UE) is to perform blind detection for the one search space set or the one search space set group based on at least two DMRS ports of the plurality of DMRS ports.

In some embodiments, the method further involves transmitting, by the base station, configuration information for the UE to transmit per-DMRS-port signal-to-interference-plus-noise ratio (SINR) on a physical uplink control channel (PUCCH) or a physical uplink shared channel (PUSCH).

According to some aspects of the disclosure there is provided a device including a processor and a computer-readable storage media. The computer-readable storage media has stored thereon, computer executable instructions, that when executed by the processor, perform a method as described above or detailed below.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A is a schematic diagram of a communication system in which embodiments of the present disclosure may occur.

FIG. 1B is another schematic diagram of a communication system in which embodiments of the present disclosure may occur.

FIG. 2 is a block diagram illustrating units or modules in a device in which embodiments of the present disclosure may occur.

FIG. 3 is a block diagram illustrating units or modules in a device in which embodiments of the present disclosure may occur.

FIG. 4 is a schematic diagram illustrating time division multiplexed (TDMed) PDCCH transmission over different beams.

FIG. 5A illustrates a schematic diagram illustrating frequency division multiplexed (FDMed) and TDMed multi-transmit receive point (TRP) PDCCH repetition.

FIG. 5B illustrates a schematic diagram illustrating single frequency network (SFN) multi-TRP PDCCH transmission.

FIG. 6 is a schematic diagram illustrating transmission and reception of a 1-port SSB with dual-polarized antennas.

FIG. 7 is a schematic diagram illustrating multiplexing of transmission from a base station to multiple UEs over two polarization directions where each UE receives over both polarization directions.

FIG. 8 is a schematic diagram illustrating transmission and reception of a 2-port SSB with dual-polarized antennas.

FIG. 9 illustrates an example of a signal flow diagram between a base station and a UE that enables reduced latency between SSB detection and multiple input multiple output (MIMO) transmission using a channel state information (CSI) report transmitted over physical uplink shared channel (PUSCH), such as a message 3 (Msg3) PUSCH.

FIG. 10 is a representation of an association between a 2-port demodulation reference signal (DMRS) and a 2-layer PDCCH according to an aspect of the present disclosure.

FIG. 11 is a schematic diagram of a portion of a network including a base station and a UE used to illustrate a 2-port DMRS and two matched polarization directions according to an aspect of the present disclosure.

FIG. 12 is a schematic diagram illustrating doubled capacity or halved overhead when implementing 2-port PDCCH according to an aspect of the present disclosure.

FIG. 13 is a representation of an association between a 2-port DMRS and a 1-layer PDCCH according to an aspect of the present disclosure.

FIG. 14 is a schematic diagram of a portion of a network including a base station and a UE used to illustrate a 2-port DMRS and one matched polarization direction according to an aspect of the present disclosure.

FIG. 15 illustrates an example of inter-apparatus polarization-based multiplexing for multiple UEs using the same beam transmitted from a network device, in accordance with embodiments of the present disclosure.

FIG. 16 is a representation of an association between a 2-port DMRS and a 1-layer PDCCH according to another aspect of the present disclosure.

FIG. 17 is a schematic diagram illustrating an example of per-DMRS-port signal-to-interference-plus-noise ratio (SINR) reporting based on 2-port DMRS according to an aspect of the present disclosure.

FIG. 18 illustrates an example of a signal flow diagram for transmission of configuration information related to a N-port DMRS and a M-layer PDCCH, in accordance with embodiments of the present disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

According to some aspects of the present disclosure there is provided a method for transmission of M-layer PDCCH, where Mis an integer, and UE blind detection over part or all M PDCCH layers with one or multiple search space (SS)-set(s) per PDCCH layer. For example, a method for transmission of 2-layer PDCCH and UE blind detection over one or both PDCCH layers with one or multiple SS-set(s) per PDCCH layer.

According to some aspects of the present disclosure there is provided a method for dynamic indication of association between 1-layer PDCCH with one or multiple SS-set(s) and one PDCCH-DMRS port among N PDCCH-DMRS ports, where N is an integer. For example, a method for dynamic indication of association between 1-layer PDCCH with one SS-set and one PDCCH-DMRS port among 2 PDCCH-DMRS ports.

According to some aspects of the present disclosure there is provided a method for changing dynamically from polarization-separated N-port DMRS and PDCCH, where N is an integer, to polarization-mixed 1-port DMRS and PDCCH. Polarization-separated means using a separate polarization direction for transmitting one port of the N-port DMRS and PDCCH, while polarization-mixed means using multiple polarization directions for transmitting the 1-port DMRS and PDCCH. For example, a method for changing dynamically from polarization-separated 2-port DMRS and PDCCH to polarization-mixed 1-port DMRS and PDCCH.

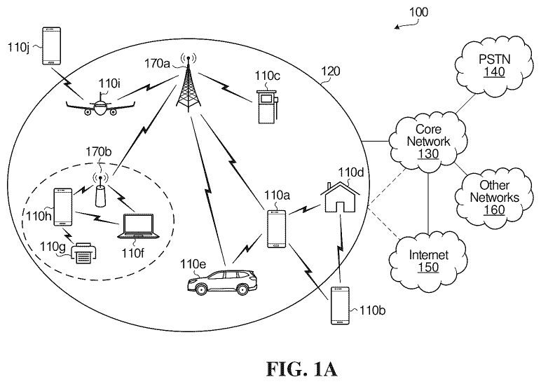

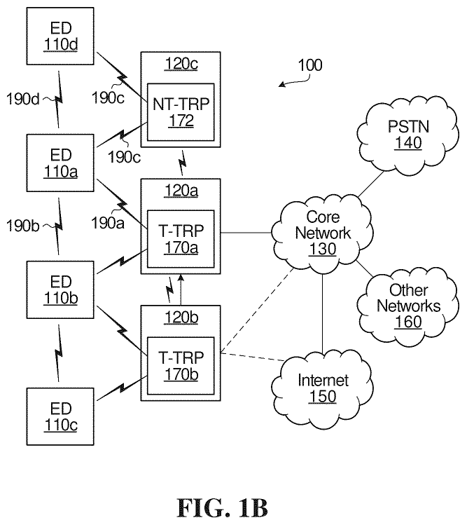

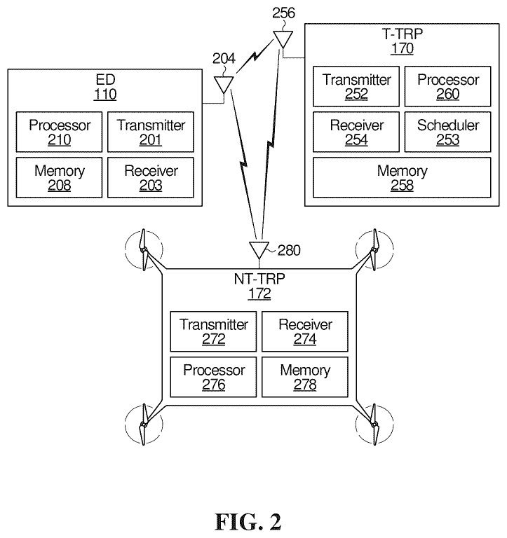

FIGS. 1A, 1B, and 2 following below provide context for the network and device that may be in the network and that may implement aspects of the present disclosure.

Referring to FIG. 1A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 1B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 1B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 1B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 1B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 1B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b, 172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b, 172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 2 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 2, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1A or 1B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

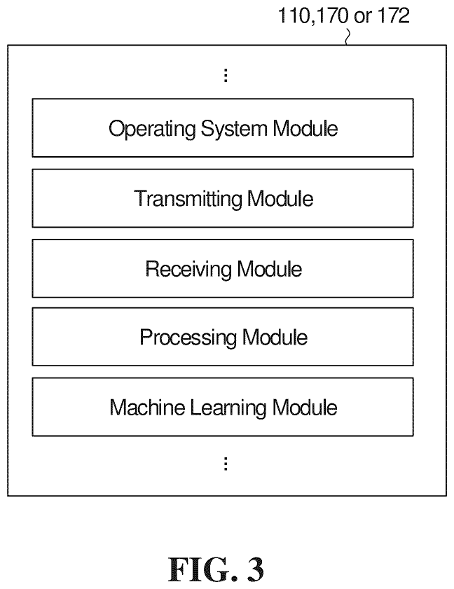

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. A new protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical uplink shared channel (PUSCH) or physical downlink control channel (PDCCH). An example of control information that is dynamically indicated is information sent in physical layer control signaling, e.g. uplink control information (UCI) sent in a PUCCH or PUSCH or downlink control information (DCI) sent in a PDCCH. A dynamic indication may be an indication in a lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH or PUSCH.

In Fourth Generation (4G) Long Term Evolution (LTE), in order to utilize multiple antennas at a base station for robust physical downlink control channel (PDCCH) transmission, space frequency block coding (SFBC) was supported for PDCCH, where 2 or 4-port cell-specific reference signal (CRS) was used for PDCCH detection. Subsequently, per-resource element (RE) precoder cycling was supported for enhanced PDCCH (EPDCCH), where demodulation reference signal (DMRS) and EPDCCH are transmitted with the same antenna port and precoder, which is also alternating per RE. In 4G LTE, PDCCH may be carried over multiple antenna ports, where control information carried by PDCCH is spread in one or more of space domain, frequency domain, or code domain for robustness.

5G NR Release 15 (R15) introduced beamformed PDCCH transmission to extend coverage of PDCCH. Different from 4G LTE, in 5G NR, per-resource element group (REG)-bundle precoder cycling was supported via using the same antenna-port and precoder for DMRS and PDCCH, but SFBC was not adopted. With such per-REG-bundle precoder cycling, PDCCH in 5G NR is transmitted with a single antenna port. In addition, when in radio resource control (RRC) CONNECTED mode, a transmission configuration indication (TCI) state is indicated per control resource set (CORESET) to facilitate UE reception. A “typeA” quasi co-location (QCL) source reference signal (RS) refers to a channel state information reference signal (CSI-RS) for tracking, also referred to as a tracking reference signal (TRS), for enabling fine time and frequency tracking at the UE. A “typeD” QCL source RS refers to the same TRS or a CSI-RS for beam management (BM) for helping the UE to determine spatial receiver (Rx) parameter. FIG. 4 illustrates TDMed PDCCH transmission over different beams for extra robustness, where different beams correspond to different TCI states. FIG. 4 illustrates a representation of a time and frequency resource 400 expressed in a two dimensional space. The x-axis represents time domain and the y-axis represents frequency domain. Two beams 405 and 407 are shown that may be representative of the beams used to transmit SS-sets from the base station to the UE. The time and frequency resource 400 includes three time slots 410, 420 and 430. Each of the three time slots 410, 420 and 430 includes a portion of the time and frequency resource 400 that is allocated for a SS-set which is associated with a CORESET transmitted on a beam corresponding to a TCI state. For example, in the first time slot 410, there is a first portion 412 of the time and frequency resource 400 for SS-set #1 that is associated with CORESET #1 transmitted on a beam corresponding to TCI #1 and there is a second portion 414 of the time and frequency resource 400 for SS-set #2 that is associated with CORESET #2 transmitted on a beam corresponding to TCI #2. As different base station transmit beams may be received by different UE receive beams, when a single receive beam is being used at the UE at a time instance, a priority rule is applied in order to derive one TypeD QCL source RS when such beam occurs or when TypeD QCL source RS overlap occurs.

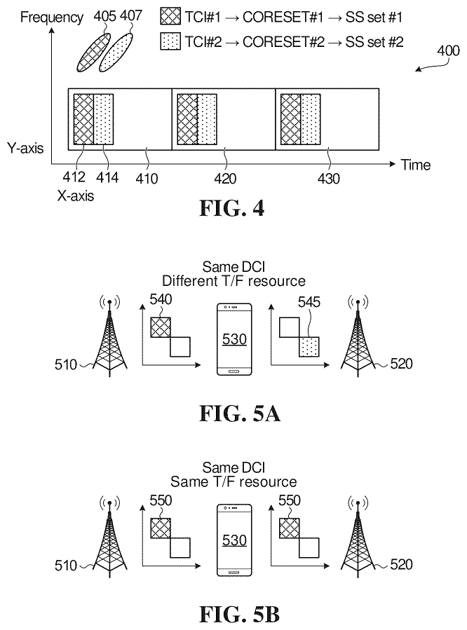

5G NR R17 introduced several transmission schemes to enhance PDCCH reliability. A first transmission scheme involves FDM or TDM multi-transmit receive point (TRP) PDCCH repetition to provide extra robustness. In this case, a linkage between two SS-sets is provided by the network so that the UE may detect a downlink control information (DCI) that may be repeatedly transmitted from two TRPs. FIG. 5A illustrates an example of a first TRP 510 and a second TRP 520 that are both communicating with a UE 530. The first TRP 510 transmits the DCI in a first time and frequency resource 540 and the second TRP 520 transmits the same DCI in a second time and frequency resource 545. The blocks 540 and 545 representing the time and frequency resources are intended to illustrate time domain (abbreviated as T in the figure) in a horizontal direction and frequency domain (abbreviated as F in the figure) in a vertical direction. The two time and frequency resource blocks 540 and 545 shown between the respective TRPs 510, 520 and the UE 530 in FIG. 5A are in the same time and frequency resource grid and as such since different time and frequency resource blocks are occupied, there is no overlap of the time and frequency resources being used by the two TRPs 510, 520.

A second transmission scheme is single frequency network (SFN) multi-TRP PDCCH transmission to utilize spatial diversity gain from multi-TRPs. In this case, the same time and frequency resource is used for transmitting one DCI from two TRPs, and two TCI-states or TRS(s) are activated for one CORESET for the UE to improve channel estimation. FIG. 5B illustrates an example of the first TRP 510 and the second TRP 520 that are both communicating with the UE 530. The first TRP 510 transmits the DCI in a first time and frequency resource 550 and the second TRP 520 transmits the same DCI in the same first time and frequency resource 550. The two blocks 550 shown between the respective TRPs 510, 520 and the UE 530 are in the same time and frequency resource grid and as such the same time and frequency resource is being used by the two TRPs 510, 520.

The solutions in 5G NR R17 described above mainly focus on reliability enhancements at the cost of extra time/frequency/spatial resources.

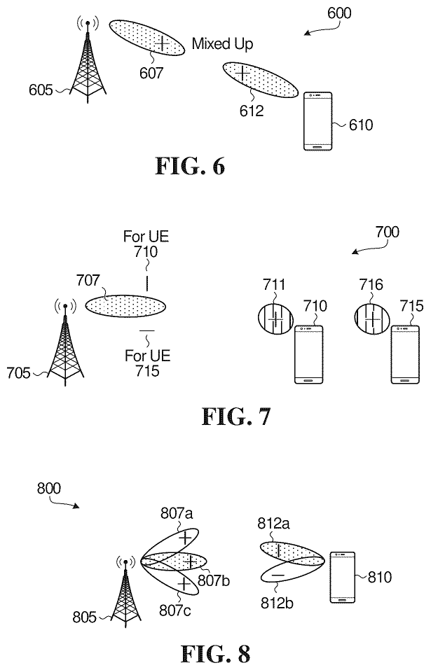

When utilizing dual-polarized antennas to transmit and receive 1-port PDCCH and associated 1-port DMRS that is used to facilitate the reception of PDCCH in 5G NR, typically the same signal, including both 1-port PDCCH and 1-port DMRS, is transmitted from dual-polarized antennas at the base station, while detection at the UE is left to UE implementation (e.g., selecting or combining signals received on UE dual-polarized antennas). FIG. 6 illustrates a portion of a network 600 that includes a base station 605 and a UE 610. A single base station beam 607 and a single UE beam 612, which are each only one beam of a number of beams that could be used at each device, are shown as an example. These beams 607, 612 may be a beam pair that has been previously measured, reported, and/or selected as a preferred beam pair for communication between the devices at the time. The base station beam 607 and UE beam 612 are each shown to include two polarization directions, i.e. horizontal polarization direction (−) and vertical polarization direction (|), which are indicated by the overlapping horizontal and vertical lines in the “+” symbol. The UE 610 measures using its dual-polarized antennas under same receiving beamforming weights. The beam measurement result reported to the base station 605 by the UE 610 is expected to be no less than the result based on measurement from either of the dual-polarized antennas at the UE 610 when considered individually, or no less than the result based on measurement from the polarized antennas at the UE 610 over either polarization direction. The manner of processing for measurement (e.g., maximum power, average power) is determined by the UE 610. The transmissions and receptions of 1-port SSB with dual-polarized antennas are illustrated in FIG. 6. Such a transmission scheme provides robustness against wireless propagation channel and UE movement and/or rotation in a heuristic way.

There may be several limitations of using 1-port PDCCH with dual-polarized antennas. A first limitation is transmission capacity may be halved as compared to the maximum capacity that is available with dual-polarized antennas at the base station and the UE, even when robustness is not a major concern. A second limitation may be inefficient interference handling if the base station tries to multiplex PDCCH for different UEs via two polarization directions, as the UE receiving over both polarization directions is unaware of potential interference pattern of other UEs and thereby cannot perform efficient interference suppression. In such a scenario the UE would not be able to help reduce interference. FIG. 7 illustrates an example of inter-apparatus polarization-based multiplexing using the same beam transmitted from a network device. FIG. 7 illustrates a portion of a network 700 that includes the base station 705, a first UE 710 and a second UE 715. A single base station beam 707 is shown. The base station beam 707 is shown to include two polarization directions, i.e. a vertical polarization direction indicated by the “|” symbol above the beam and a horizontal polarization direction indicated by the “−” symbol below the beam. The UEs 710 and 715 are both receiving signals on both polarization directions (as indicated by symbol “+” on each UE beam, UE beam 711 for the first UE 710 and UE beam 716 for the second UE 715). The UEs 710, 715 may be unable to detect the signals effectively, as the UEs 710, 715 are unaware of how the intended signal is transmitted in the polarization domain or how the potential interference may come in the polarization domain, and thereby the UEs 710, 715 cannot perform efficient interference suppression and signal reception.

These above described limitations continue to exist with R17 multi-TRP PDCCH transmission schemes.

Some embodiments of the present disclosure provide methods to address one or more of the drawbacks mentioned above, and in particular to define N-port PDCCH, where N is an integer, having an increased maximum PDCCH capacity as compared to previous schemes and enable flexible tradeoff between capacity and reliability by adaptively exploiting dual-polarized antennas at the base station and the UE. To this end, some relevant background is provided below.

In a co-pending application (PCT Application PCT/CN2022/112501 filed on Aug. 15, 2022), the Assignee of both that application and the present application describes a method of implementing 2-port SSB to exploit dual-polarized antennas for reducing latency and/or overhead for beam-based initial access, especially for mmWave frequency bands. With such a 2-port SSB, each SSB-port is transmitted via one or more base station antenna over one polarization direction (e.g., −45 or +45 degree slant polarization direction) or over one polarization direction relative to a reference plane, for example the surface of the earth (e.g., vertical or horizontal polarization direction). The dual-polarized antennas at the base station may apply the same or different beamforming weights (e.g., same or different beams). For a case where the base station applies the same beamforming weight (e.g., same beam) on the base station antennas over two polarization directions, with a differentiation of polarization directions of base station antennas using 2-port SSB and such knowledge provided to the UE, the UE may be able to decouple the UE dual-polarized antennas and measure two UE receive beams simultaneously, as illustrated in FIG. 8. In this way, the latency for beam-based initial access may be reduced. It is worth noting that the base station and the UE are capable of transmitting and receiving with different beamforming weights using antennas over two polarization directions.

FIG. 8 illustrates a portion of a network 800 that includes a base station 805 and a UE 810. Three base station transmit beams 807a, 807b and 807c are shown. Each of the base station transmit beams 807a, 807b and 807c are shown to include two polarization directions indicated by the overlapping horizontal and vertical lines that are represented by the “+” symbol. The UE 810 is shown to have two concurrent receive beams over two polarization directions. A first beam 812a is shown to transmit or receive over vertical polarization direction (|) and a second beam 812b is shown to transmit or receive over horizontal polarization direction (−). The two polarization directions at the UE 810 may shift as the UE 810 changes its orientation or switches receiving panels or antennas. The two concurrent UE receive beams 812a and 812b may help reduce latency for UE-side beam sweeping during initial access procedure.

In another co-pending application (PCT Application PCT/CN2022/118079 filed on Sep. 9, 2022), the Assignee of both that application and the present application describes a method to exploit dual-polarized antennas at the base station and the UE to enable early MIMO transmission during initial access or right after initial access, or both. In particular, a UE may be requested to report 2-port CSI measured from 2-port SSB and carried over PUSCH, for example Msg3-PUSCH. The 2-port SSB may be transmitted from dual-polarized antennas at the base station, i.e., each SSB-port corresponding to polarized antennas at the base station over one polarization direction (e.g., −45 or +45 degree slant polarization direction) or one polarization direction relative to a reference plane (e.g., vertical or horizontal polarization direction in relative to the surface of the earth). The 2-port CSI may consist of one or more of rank indicator (RI), channel quality indicator (CQI) and precoding matrix indicator (PMI) mainly for single-user multiple input multiple output (MIMO) transmission, and/or per-SSB-port SINR report that reflects the quality or isolation, or both, of polarized sub-channels (e.g., vertical polarization direction, horizontal polarization direction) to enable intra-UE multiplexing or inter-UE multiplexing of same signal/channels or different signal/channels.

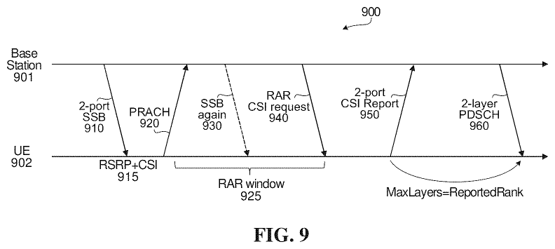

FIG. 9 illustrates an example of a signal flow diagram 900 for signaling that occurs between a base station 901 and a UE 902 that may reduce latency between SSB detection at the UE 902 and MIMO transmission by the base station 901 by using a CSI report transmitted over PUSCH or PUCCH as described in further detail in co-pending application Assignee Reference 9423941PCT01. The CSI report is associated with one or more SSBs transmitted over 2 antenna ports because the CSI report is determined based on measurement of the one or more 2-port SSBs. In step 910, the base station 901 transmits on at least one beam, one or more 2-port SSBs using dual-polarized antennas of the base station 901. At step 915, the UE 902 measures the reference signal received power (RSRP) of the one or more 2-port SSBs and may also determine the CSI based on measurement of the one or more 2-port SSBs or the 2-port SSB associated with the PRACH transmission. The CSI report may be referred to as 2-port CSI report as the CSI report is based on measurement of the one or more 2-port SSBs or the 2-port SSB associated with the PRACH transmission. In step 920, the UE 902 transmits a random access preamble on a physical random access channel (PRACH) to the base station 901. In some implementations, the base station 901 may periodically transmit, on at least one beam, the one or more 2-port SSBs using dual-polarized antennas of the base station 901. Such periodic transmission of the one or more 2-port SSB(s) may occur again, as shown in step 930, within a random access response (RAR) window 925 or within a time period between transmission of the PRACH and reception of a request for a CSI report that is transmitted by the base station 901 at step 940. In step 940, the base station 901 transmits a request to the UE 902 for a CSI report. Upon receiving the request for a CSI report, the UE 902, in step 950, transmits a response to the CSI report request. In step 960, after the base station 901 receives the CSI report, the base station 901 enables multi-layer transmission to the UE 902.

Some aspects of the present description provide a method to achieve an increase in the maximum PDCCH capacity and enable flexible tradeoff between capacity and reliability by exploiting dual-polarized antennas at the base station and the UE. In some embodiments, the increase in the maximum PDCCH capacity may be up to double of the maximum capacity of previous methods. In some embodiments, PDCCH overhead may be reduced by exploiting dual-polarized antennas at the base station and the UE. In some embodiments, PDCCH overhead may be reduced by half as compared to previous methods.

Aspects of the disclosure provide a N-port PDCCH-DMRS, where N is an integer, where each PDCCH-DMRS port is transmitted via base station antennas on one polarization direction. For the sake of explanation, and not to limit the disclosure, N will be considered as equal to 2. With 2-port PDCCH-DMRS where each PDCCH-DMRS port is transmitted via base station antennas on one polarization direction, the UE may be able to estimate the channels on both polarization directions separately and may perform interference suppression when desired. Depending on the channel condition, in some embodiments, the UE may be configured to monitor M-layer PDCCH corresponding to N-port PDCCH-DMRS, where N and M are integers and M is less than or equal to N, with which a DCI may be transmitted on any one layer of M-layer PDCCH. Again, for the sake of explanation, and not to limit the disclosure, M will be considered as equal to 1 or 2, and N will be considered as equal to 2. In some embodiments, for 2-port PDCCH-DMRS and 2-layer PDCCH, the maximum PDCCH capacity from the network perspective may be doubled compared with 1-port PDCCH-DMRS and 1-layer PDCCH, enabling a flexible tradeoff between PDCCH capacity and resource overhead. In some embodiments, the UE may be configured to monitor 1-layer PDCCH corresponding to one of N PDCCH-DMRS ports (where N is integer) and one polarization direction, with which a DCI may be transmitted on the indicated PDCCH layer only. For the sake of explanation, and not to limit the disclosure, N will be considered as equal to 2. In some embodiments, with the provided correspondence between 1-layer PDCCH and one of 2-port PDCCH-DMRS ports and one polarization direction, a UE is informed about the polarization direction of 1-layer PDCCH and the associated DMRS port and also provided information related to the other DMRS port for estimating interfering channel and/or interference from the other polarization direction, which can reduce complexity and power consumption at the UE for receiving PDCCH with interference suppression.

In some embodiments, base station to UE signaling is also provided to instruct the UE to switch from N-port PDCCH-DMRS and M-layer PDCCH back to 1-port PDCCH-DMRS and 1-layer PDCCH or from N-port PDCCH-DMRS and 1-layer PDCCH back to 1-port PDCCH-DMRS and 1-layer PDCCH. The 1-port PDCCH-DMRS and 1-layer PDCCH may be transmitted via base station antennas on both polarization directions when extra robustness is desired.

The use of the term DMRS in this disclosure, if not specified otherwise, refers for PDCCH-DMRS.

Several examples of 2-port DMRS pattern for PDCCH will now be described. In some embodiments, two DMRS ports may be differentiated by using FDM or by using frequency domain orthogonal cover codes (FD-OCCs) or by using TDM or by using time domain orthogonal cover codes (TD-OCCs) or by using FDM and TDM or by using frequency and time domain orthogonal cover codes (FD+TD-OCCs). A base station may provide an indication of polarization direction reference for receiving 2-port DMRS at a UE. For example, in some embodiments, 2-port DMRS may be indicated as in quasi-co-location (QCL) in terms of polarization direction(s) or in quasi-co-polarization-direction (QCPD) to 2-port SSB or 2-port tracking reference signal (TRS). In this case, one DMRS port of 2-port DMRS is transmitted with same polarization direction as one SSB or TRS port of 2-port SSB or 2-port TRS. In some embodiments, 2-port DMRS may be configured with direct indication of polarization direction, such that DMRS port #0 or DMRS port #1 is transmitted on a vertical polarization direction or a horizontal polarization direction, respectively. At the receiver side (i.e. at the UE), after being provided with at least one of a QCL indication in terms of polarization direction(s) or QCPD indication or direct polarization direction indication, the UE may select and adjust the dual-polarized antennas to match the polarization directions of the base station. In some embodiments, this may involve switching UE receive antennas, or performing projection onto a particular polarization plane or direction, or combining signals received from dual-polarized antennas with certain weights. The UE may buffer received signal and then estimate the channel or the interfering channel from 2-port DMRS, or both, for subsequent blind detection (BD). In some embodiments, the UE may utilize the interfering channel estimated from 2-port DMRS to perform interference suppression.

Three examples will now be described pertaining to methods and apparatus for implementing 2-port PDCCH.

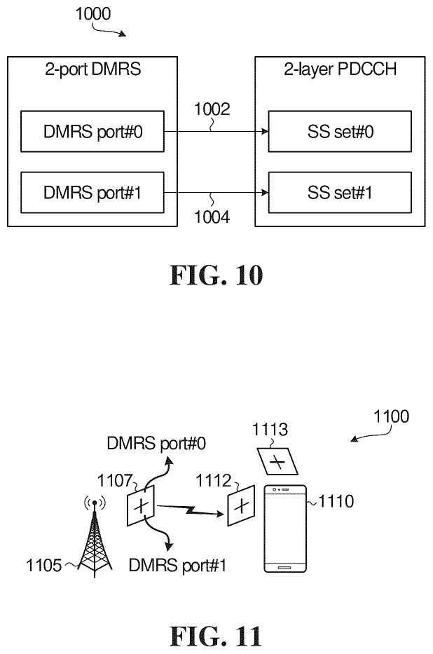

In a first example, a UE may be configured to receive two PDCCH layers over two DMRS ports. Each PDCCH layer may correspond to one or multiple CORESET(s), one or multiple SS-set(s), or one or multiple SS-set groups (SSSGs), where each SSSG includes one or multiple SS-set(s). The case of one SS-set or SSSG per PDCCH layer is used for subsequent illustrations, however it is to be understood that in other embodiments more than one SS-set or SSSG may occur per PDCCH layer, and in other embodiments one or multiple CORESET(s) may occur per PDCCH layer, with which the UE may find the corresponding SS sets for BD based on association between CORESET and SS set. In such configurations, the UE may perform BD on the SS-set or SSSG on each layer when both SS-set(s) or SSSGs are activated for the UE, as depicted in FIG. 10. FIG. 10 illustrates a representation of an example of an association 1000 for the case of a 2-port DMRS and a 2-layer PDCCH. The association 1000 illustrates how DMRS port #0 is associated 1002 with SS-set #0, which may be considered as a first PDCCH layer, and how DMRS port #1 is associated 1004 with SS-set #1, which may be considered as a second PDCCH layer. The example of a 2-port DMRS is merely an example and more generally N-port DMRS, where N is an integer, may be considered.

When performing BD for the first PDCCH layer over a first DMRS port of the two DMRS ports, the UE may assume the second DMRS port may be used to estimate the cross-layer or cross polarization-direction interfering channel and may perform interference rejection or mitigation as desired. Similarly, when performing BD for the second PDCCH layer over a second DMRS port of the two DMRS ports, the UE may assume the first DMRS port may be used to estimate the cross-layer or cross polarization-direction interfering channel and may perform interference rejection or mitigation as desired. When the UE is configured to operate in this manner, performing BD on both PDCCH layers may enable the base station to transmit DCI to the UE over any one of the two SS-sets or PDCCH layers. The two SS-sets each correspond to a respective polarization direction. In some embodiments, in order to reduce the complexity involved in performing BD, which may involve interference suppression at the UE, the CORESETs associated with the two SS-sets may have an aligned REG boundary, e.g., the size and grid of REG in CORESETs associated with one SS-set or PDCCH layer is the same as the size and grid of REG in CORESETs associated with the other SS-set or PDCCH layer, where the grid may include starting/ending positions of REGs as well as its granularity. In some embodiments, such an implementation may be used when two reported per-SSB-port-SINRs from 2-port SSB are both above a certain threshold. Such a scenario of the two reported per-SSB-port-SINRs from 2-port SSB both being above a certain threshold may occur when transmit polarization directions at the base station and receive polarization directions at the UE are well matched, especially in line-of-sight channel conditions.

FIG. 11 illustrates an example portion of a network 1100 that includes a base station 1105 and a UE 1110. The base station 1105 is shown to include an antenna panel 1107 that includes dual-polarized antennas i.e. two polarization directions including a vertical polarization direction indicated by the “|” symbol and a horizontal polarization direction indicated by the “−” symbol, that collectively are shown as a “+” symbol. In the example of FIG. 11, the vertical polarization direction is shown to be used for transmitting DMRS port #0 and the horizonal polarization direction is shown to be used for transmitting DMRS port #1. The UE 1110 is shown to include two antenna panels 1112 and 1113 that each include dual-polarized antennas. First antenna panel 1112 of the UE 1110 is shown to have polarization directions that are well-matched with polarization directions of the antenna panel 1107 of the base station 1105. Second antenna panel 1113 of the UE 1110 does not have polarization directions well matched with polarization directions of the antenna panel 1107 of the base station 1105 at this instance of time. However, if the UE 1110 were to reorient itself, the second antenna panel 1113 may be well-matched to the polarization directions of the antenna panel 1107 of the base station 1105 at a later time instance. Furthermore, both the first antenna panel 1112 and the second antenna panel 1113 may be used together to receive signals from, or transmit signals to, the base station 1105.

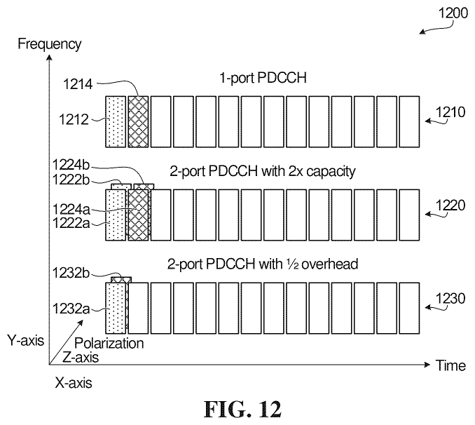

When the UE is configured to operate in this manner, performing BD on both SS-set(s) or both PDCCH layers may enable the maximum PDCCH capacity to be doubled as compared with the 1-port PDCCH case. Alternatively, it may be considered that the resource overhead for offering the same PDCCH capacity may be halved as compared with the 1-port PDCCH case. FIG. 12 illustrates a schematic representation of three versions of PDCCH capacity expressed in a three dimensional space. The x-axis represents time domain, the y-axis represents frequency domain and the z-axis represents polarization domain. A first PDCCH capacity illustrates how a first two symbols 1212 and 1214 of a first time and frequency resource 1210 are used for transmission of the 1-port PDCCH. A second PDCCH capacity illustrates how the first and second symbols of a first time and frequency and polarization resource 1220 are used for transmission of the 2-port PDCCH, where each port of the 2-port PDCCH is on a different polarization direction in the polarization domain. For example, the first and second symbols 1222a and 1224a are used for transmission of a first port of the 2-port PDCCH over a first polarization direction in the polarization domain, and the first and second symbols 1222b and 1224b are used for transmission of a second port of the 2-port PDCCH over a second polarization direction in the polarization domain. This enables the capacity to be doubled as compared with the 1-port PDCCH case. A third PDCCH capacity illustrates how the first symbol of a second time and frequency and polarization resource 1230 is used for transmission of the 2-port PDCCH, where each port of the 2-port PDCCH is on a different polarization direction in the polarization domain. For example, the first symbol 1232a is used for transmission of a first port of the 2-port PDCCH over a first polarization direction in the polarization domain, and the first symbol 1232b is used for transmission of a second port of the 2-port PDCCH over a second polarization direction in the polarization domain. This enables the resource overhead to be halved as compared with the 1-port PDCCH case. In the example above, the term of port may be replaced as layer, as one antenna port may be used to carry one PDCCH-DMRS and corresponding PDCCH layer, with which one PDCCH port is equivalent or similar to one PDCCH layer.

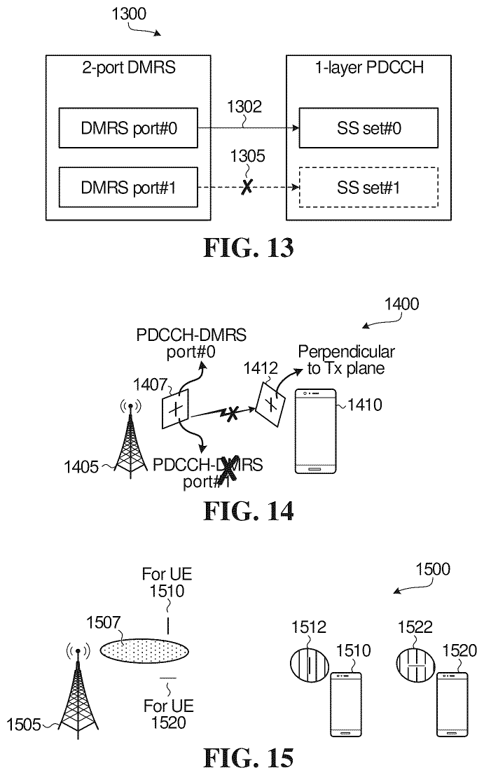

In a second example, a UE may be configured to receive a 1-layer PDCCH and corresponding SS-set or SSSG, where the SSSG may include one or multiple SS-set(s), over one port of the 2-port DMRS. In general, one PDCCH layer may correspond to one or multiple CORESET(s), one or multiple SS-set(s), or one or multiple SS-set groups (SSSGs), where each SSSG includes one or multiple SS-set(s). The case of one SS-set or SSSG per PDCCH layer is used for subsequent illustrations, however it is to be understood that in other embodiments more than one SS-set or SSSG may occur per PDCCH layer, and in other embodiments one or multiple CORESET(s) may occur per PDCCH layer, with which the UE may find the corresponding SS sets for BD based on association between CORESET and SS set. For this case with one SS-set over 1 PDCCH layer being described here, only 1 SS-set is selected or activated for this UE. FIG. 13 illustrates a representation of an example of an association 1300 for the case of a 2-port DMRS and a 1-layer PDCCH. The association 1300 illustrates how SS set #0, which may be considered as a first PDCCH layer, is associated 1302 with DMRS port #0. However, SS set #1, which may be considered as a second PDCCH layer, is not associated 1305 with DMRS port #1. The example of a 2-port DMRS is merely an example and more generally N-port DMRS, where N is an integer, may be considered.

When the UE is configured to operate in this manner, BD is performed by the UE over the indicated PDCCH layer and corresponding SS-set or SSSG only, during which the UE assumes that the other DMRS port of the two ports may be used for estimating the cross-layer or cross polarization-direction interfering channel. In some embodiments, the UE may perform interference rejection or mitigation as desired. In some embodiments, the UE may be configured with two SS-sets or two SSSGs each associated with one DMRS port of 2-port DMRS and then the UE may be dynamically configured or indicated with one active SS-set or SSSG selected from among the two configured SS-sets or two configured SSSGs, which may be considered as two PDCCH layers. In some embodiments, the UE may be configured with one SS-set or SSSG and then be dynamically configured or indicated with the particular DMRS port that the configured SS-set or SSSG is associated with.

In some embodiments, such an implementation may be used when one of two reported per-SSB-port-SINRs from 2-port SSB is above a certain threshold. This may happen when the transmit polarization directions at the base station and the receive polarization directions at the UE are mis-matched (e.g., when one polarization direction at the UE is perpendicular to the transmit polarization plane at the base station, while the other polarization direction at the UE is still aligned or in parallel to the transmit polarization plane at the base station). FIG. 14 illustrates an example portion of a network 1400 that includes a base station 1405 and a UE 1410. The base station 1405 is shown to include an antenna panel 1407 that includes dual-polarized antennas. The UE 1410 is shown to include a single antenna panel 1412 that includes dual-polarized antennas. The UE antenna panel 1412 of the UE 1410 is shown to have only one polarization direction that is well matched with one of the two polarization directions of the antenna panel 1407 of the base station 1405 at this instance of time. In a particular example, PDCCH-DMRS port #0 that is transmitted on a first polarization direction, which is a vertical polarization direction, at the base station 1405 is aligned with a first polarization direction at the UE 1410, which is also a vertical polarization direction. However, PDCCH-DMRS port #1 that is transmitted on a second polarization direction at the base station 1405 is not aligned with a second polarization direction at the UE 1410. Therefore, the UE 1410 may be configured to activate the SS-set or SSSG associated with PDCCH-DMRS port #0. In some embodiments, the UE 1410 may be configured to deactivate the SS-set or SSSG associated with PDCCH-DMRS port #1.

In some embodiments, one active SS-set or SSSG may be dynamically configured or selected from among two configured SS-set(s) or SSSGs. In some embodiments, one SS-set or SSSG may be dynamically indicated to be associated with one DMRS port from among two DMRS ports. In some embodiments, the base station may be able to transmit to the UE over a suitable polarization direction at a given time, thereby enabling PDCCH transmission over one polarization direction even with UE movement or rotation, or both. When configured appropriately, UE complexity with regard to performing BD may be reduced, i.e., on one SS-set or SSSG instead of two SS-set(s) or SSSGs as in the first example above, i.e. related to FIG. 10. In some embodiments, when the base station 1405 sends such configuration information, the UE 1410 may turn off unused antennas to save power. For example, in FIG. 14, the UE 1410 may only keep on the antennas over the vertical polarization direction to receive PDCCH.

In some embodiments, when using dynamic configuration or selection of one active SS-set or SSSG among two configured SS-sets or SSSGs or association between one SS-set or SSSG and one DMRS port among two DMRS ports, the base station may be able to multiplex PDCCH transmissions towards multiple UEs over different polarization directions. FIG. 15 illustrates an example of inter-apparatus polarization-based multiplexing using the same beam transmitted from a base station, in accordance with embodiments of the present disclosure. FIG. 15 illustrates a portion of a network 1500 that includes the base station 1505, a first UE 1510 and a second UE 1520. A single base station beam 1507 is shown. The base station beam 1507 is shown to include two polarization directions, i.e. a vertical polarization direction indicated by the “|” symbol above the beam and a horizontal polarization direction indicated by the “−” symbol below the beam. A single UE beam 1512, 1522 is shown for each UE 1510, 1520. The UE beam 1512 is shown to be able to transmit or receive with a single polarization direction, i.e. vertical polarization direction, as indicated by the “|” symbol within the beam. The UE beam 1522 is shown to be able to transmit or receive with a single polarization direction, i.e. horizontal polarization direction, as indicated by the “−” symbol within the beam. Signal transmitted on the vertical polarization direction by the base station 1505 are detected and received by a beam 1512 over a vertical polarization direction at the first UE 1510, and signal transmitted on the horizontal polarization direction by the base station 1505 are detected and received by a beam 1522 over a horizontal polarization direction at the second UE 1520.

In some embodiments, the first UE 1510 and the second UE 1520 are each aware of 2-port DMRS, e.g. the first UE 1510 is receiving DMRS port #0 and corresponding PDCCH layer over vertical polarization direction. The first UE 1510 is aware of DMRS port #1 which is transmitted on horizontal polarization direction, and may utilize information pertaining to DMRS port #1 for estimating a cross-layer or a cross-polarization-direction interfering channel and for performing interference suppression and nulling, as appropriate.

Whereas 2-port DMRS is provided to UEs in both the first example (related to FIG. 10) and the second example (related to FIG. 13), in some embodiments, PDCCH transmissions towards UEs with corresponding configurations may co-exist on the same time and frequency resource grid and share the same 2-port DMRS.

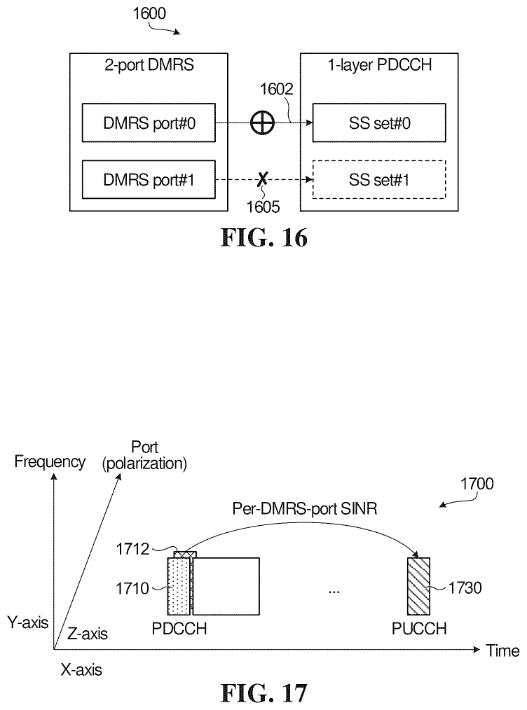

In a third example, a UE may be dynamically configured or may be provided by the base station an indication to change from 2-port DMRS to 1-port DMRS and thereby receive a 1-layer PDCCH and a corresponding SS-set or SSSG over the 1-port DMRS, i.e., there is only 1 active SS-set or SSSG for the UE. FIG. 16 illustrates a representation of an example of an association 1600 for the case of a 2-port DMRS and a 1-layer PDCCH. The association 1600 illustrates how SS set #0 is associated 1602 with DMRS port #0, while both DMRS port #1 and SS set #1 are deactivated 1605. In this case, DMRS port #0 is transmitted on two polarization directions, as indicated by the “+” symbol within the circle between DMRS port #0 and SS set #0, for extra robustness against UE movement or rotation, or both. The example of a 2-port DMRS is merely an example and more generally N-port DMRS, where N is an integer, may be considered.

In some embodiments, with such configuration, the UE is expected to perform BD over the indicated PDCCH layer and corresponding SS-set or SSSG only. In a particular example, the UE may be configured with two SS-sets or SSSGs, each associated with one DMRS port and then the UE is dynamically configured or an indication is provided to the UE to use one DMRS port and one active SS-set or SSSG selected from among the two configured SS-sets or SSSGs, where the one DMRS port is transmitted over two polarization directions, e.g. the one DMRS port is in QCL in terms of polarization direction(s) or in QCPD to 2-port SSB or 2-port tracking reference signal (TRS). In another example, the UE may be configured with one SS-set or SSSG and 2-port DMRS and then the UE is dynamically configured or an indication is provided to the UE to enter into a mode with only one DMRS port and one SS-set or SSSG, where the one DMRS port is transmitted over two polarization directions, e.g. the one DMRS port is in QCL in terms of polarization direction(s) or in QCPD to 2-port SSB or 2-port tracking reference signal (TRS).

In this third example, as illustrated in FIG. 16, the UE assumes the 1-port DMRS and 1-layer PDCCH are transmitted over both polarization directions. In the case where 2-port DMRS is generated via FDM or TDM in different REs, the UE may assume REs for DMRS port #1 are used for DMRS port #0 or assume REs for DMRS port #0 are used for DMRS port #1. In the case where 2-port DMRS is generated via FDM-OCC or TDM-OCC in different REs, the UE may assume the orthogonal cover codes are not applied and REs for DMRS port #1 are used for DMRS port #0 or may assume REs for DMRS port #o are used for DMRS port #1.

In some embodiments, such configuration may be used when the two reported per-SSB-port-SINR(s) from 2-port SSB are increasing and decreasing and the larger per-SSB-port-SINR of the two per-SSB-port-SINRs alternates over time. Such a scenario may occur when the UE is rotating.

This third example may provide additional robustness for a wireless propagation channel and when the UE is rotating or moving. In some embodiments, PDCCH transmissions for UEs according to the third example may co-exist with PDCCH transmissions for UEs according to the first example (related to FIG. 10) or the second example (related to FIG. 13) in a TDM manner or an FDM manner over the time and frequency resource grid.

In some embodiments, a UE may be configured to report per-DMRS-port SINR based on 2-port PDCCH-DMRS in the HARQ/ACK feedback for the DCI or the scheduled PDSCH. In some embodiments, the two PDCCH-DMRS ports are transmitted over base station antennas on two different polarization directions. Such reporting may provide more chances for per-polarization-direction measurement and reporting, in an effort to cope with UE movement or rotation. FIG. 17 illustrates a schematic representation of reporting per-DMRS-port SINR based on 2-port PDCCH-DMRS, where the reporting may be transmitted together with the HARQ/ACK feedback. The x-axis represents time domain, the y-axis represents frequency domain and the z-axis represents polarization domain. In a first symbol, transmission of the 2-port PDCCH-DMRS occurs, where each port of the 2-port PDCCH-DMRS is on a different polarization direction in the polarization domain. For example, the first symbol is used for transmission of a first port of the 2-port PDCCH-DMRS 1710 that is transmitted over a first polarization direction in the polarization domain, and the first symbol is also used for transmission of a second port of the 2-port PDCCH-DMRS 1712 that is transmitted over a second polarization direction in the polarization domain. The UE may be configured to report per-DMRS-port SINR based on 2-port PDCCH-DMRS in the HARQ/ACK feedback for the DCI or the scheduled PDSCH carried on a PUSCH or a PUCCH 1730. In some embodiments, when deriving per-DMRS-port SINR for DMRS port #0, the signal power or average signal power received on DMRS port #1 may be considered as interference.

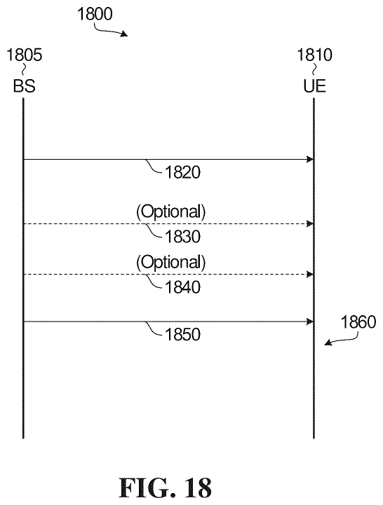

FIG. 18 illustrates an example of a signal flow diagram for transmission of configuration information related to an association between at least one PDCCH layer and at least one DMRS port from more than one available DMRS port between a base station (BS) 1805 and a UE 1810, in accordance with embodiments of the present disclosure.

At step 1820, the base station 1805 transmits to the UE 1810 one or more signals to convey configuration information that includes an indication of an association between at least one PDCCH layer and at least one DMRS port from more than one available DMRS ports.

In FIG. 18, steps 1830 and 1840 are shown to be optional steps. These two optional steps may be different for different methods. In a first example method, which generally corresponds to the second example described above (i.e. related to FIG. 13), at optional step 1830, the base station 1805 transmits configuration information to the UE 1810 indicating an association between one or more search space set or search space set group and one or more DMRS port. In some embodiments, the association is that two search space sets or two search space set groups are each associated with one PDCCH layer and one DMRS port. In some embodiments, the association is that one PDCCH layer comprising one search space set or one search space set group is associated with one DMRS port from a plurality of DMRS ports. The indication sent in optional step 1830 may also be carried in step 1820.

As part of the first method, at optional step 1840, the base station 1805 transmits to the UE 1810 an indication that the UE 1810 is to perform blind detection. In some embodiments, the blind detection is for at least one of: a specific PDCCH layer; a specific search space set or a specific search space set group of the two PDCCH layers; the two search space sets or the two search space set groups, or multiple specific PDCCH layers. In some embodiments, the blind detection is for one PDCCH layer comprising one search space set or one search space set group based on a particular DMRS port from a plurality of DMRS ports. The indication sent in optional step 1840 may also be carried in step 1820.

In a second example method that also includes optional steps 1830 and 1840, which generally corresponds to the third example described above (i.e. related to FIG. 16), at optional step 1830, the base station 1805 transmits configuration information to the UE 1810 indicating that one search space set or one search space set group is associated with a plurality of DMRS ports. The indication sent in optional step 1830 may also be carried in step 1820.

As part of the second method, at optional step 1840, the base station 1805 transmits to the UE 1810 an indication that the UE 1810 is to perform blind detection for one search space set or one search space set group based on at least two DMRS ports selected from a plurality of DMRS ports. The indication sent in optional step 1840 may also be carried in step 1820.

At step 1850, the base station 1805 transmits at least one PDCCH layer. Each PDCCH layer of the at least one PDCCH layer includes one or more search space set or one or more search space set group.

At step 1860, the UE 1810 performs blind detection.

In some embodiments, blind detection is performed on the one or more search space set or the one or more search space set group on each PDCCH layer of the at least one PDCCH layer.

In some embodiments, performing blind detection involves performing blind detection on two search space sets or two search space set groups, each on a respective PDCCH layer, wherein each PDCCH layer is associated with one DMRS port. In some embodiments, performing blind detection involves performing blind detection on two search space sets or two search space set groups, each on a respective PDCCH layer, wherein a first PDCCH layer is transmitted over a different polarization direction than the second PDCCH layer.

In some embodiments, performing blind detection involves performing blind detection on the one or more search space set or the one or more search space set group on each PDCCH layer of the at least one PDCCH layer. In some embodiments, performing blind detection involves performing blind detection on the one search space set or the one search space set group on one PDCCH layer, wherein the PDCCH layer is associated with one DMRS port or is transmitted over a single polarization direction.

In some embodiments, performing blind detection involves performing blind detection on the one or more search space set or the one or more search space set group on each PDCCH layer of the at least one PDCCH layer. In some embodiments, performing blind detection involves performing blind detection on one search space set or one search space set group on one PDCCH layer, wherein the PDCCH layer is associated with a plurality of DMRS ports or is transmitted over a plurality of polarization directions.

In some embodiments, in the method described in FIG. 18, the UE 1810 may perform interference mitigation by assuming that a second DMRS port or a second PDCCH layer is interference for a first DMRS port or a first PDCCH layer, respectively.

In some embodiments, in the method described in FIG. 18, the UE 1810 may receive configuration information for the UE 1810 to transmit per-DMRS-port signal-to-interference-plus-noise ratio (SINR) on a physical uplink control channel (PUCCH) or a physical uplink shared channel (PUSCH).

In some embodiments, the present disclosure may enable doubled maximum PDCCH capacity by exploiting dual-polarized antennas at the base station and the UE as compared to previous methods. In some embodiments, the present disclosure may enable flexible tradeoff between PDCCH capacity, resource overhead, and reliability.

In some embodiments, the present disclosure may enable reduced UE complexity as well as power savings via UE receiving over a single polarization direction with a fewer number of antennas.

In some embodiments, the present disclosure may enable on-demand robustness with regard to a wireless propagation channel and UE rotation as opposed to using blind robustness that does not provide for distinguishability between scenarios with different reliability requirements.

While one or more steps of the methods described above are based on dual-polarized antennas with vertical or horizontal polarization directions, or both, it should be understood that the methods may be performed using dual-polarized antennas with ±45 degree slant polarization directions. Similarly, while one or more steps of the methods described above are based on dual-polarized antennas with 90 degree offset in polarization direction (i.e. vertical/horizontal polarization directions, ±45 degree slant polarization directions), it should be understood that the methods may be performed using dual-polarized antennas with a non-90 degree offset (e.g. 60 degree) in polarization direction. Furthermore, while one or more steps of the methods described above are based on dual-polarized antennas with two polarization directions, it should be understood that the methods may be performed using antenna structures or architectures that may be considered such that the network device or the apparatus is equipped with antennas capable of transmitting or receiving over M polarization directions, where M is an integer greater than 2. In this case, the 2-port SSB or CSI-RS resource mentioned in embodiments or examples illustrated above or elsewhere in the present disclosure may be replaced as M-port SSB or CSI-RS resource.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
receiving an indication of an association between at least one physical downlink control channel (PDCCH) layer and at least one demodulation reference signal (DMRS) port from more than one available DMRS port, wherein each PDCCH layer of the at least one PDCCH layer comprises one or more search space sets, or one or more search space set groups, and each DMRS port of the at least one DMRS port is transmitted over one polarization direction,
performing blind detection on the one or more search space sets or the one or more search space set groups on each PDCCH layer of the at least one PDCCH layer.

2. The method of claim 1, wherein the performing the blind detection comprises:
performing the blind detection on two search space sets or two search space set groups, each of the two search space sets or the two search space set groups on a respective PDCCH layer, wherein each PDCCH layer is associated with one DMRS port.

3. The method of claim 1, wherein the performing blind detection comprises:
performing the blind detection on two search space sets or two search space set groups, each of the two search space sets or the two search space set groups on a respective PDCCH layer, wherein a first PDCCH layer corresponding to a first search space set or a first search space set group of the two search space sets or the two search space set groups is transmitted over a different polarization direction than a second PDCCH layer corresponding to a second search space set or a second search space set group of the two search space sets or the two search space set groups.

4. The method of claim 1, wherein the performing the blind detection comprises:
performing the blind detection on one search space set or one search space set group on one PDCCH layer, wherein the one PDCCH layer is associated with one DMRS port or is transmitted over a single polarization direction.

5. The method of claim 1, wherein the performing the blind detection comprises:
performing the blind detection on one search space set or one search space set group on one PDCCH layer, wherein the PDCCH layer is associated with a plurality of DMRS ports or is transmitted over a plurality of polarization directions.

6. A device comprising:
one or more processors, when executing program instructions stored in the device, cause the device to perform:
receiving an indication of an association between at least one physical downlink control channel (PDCCH) layer and at least one demodulation reference signal (DMRS) port from more than one available DMRS port, wherein each PDCCH layer of the at least one PDCCH layer comprises one or more search space sets, or one or more search space set groups, and each DMRS port of the at least one DMRS port is transmitted over one polarization direction; and
performing blind detection on the one or more search space sets or the one or more search space set groups on each PDCCH layer of the at least one PDCCH layer.

7. The device of claim 6, wherein the performing the blind detection comprises:
performing the blind detection on two search space sets or two search space set groups, each of the two search space sets or the two search space set groups on a respective PDCCH layer, wherein each PDCCH layer is associated with one DMRS port.

8. The device of claim 6, wherein the performing the blind detection comprises:
performing the blind detection on two search space sets or two search space set groups, each of the two search space sets or the two search space set groups on a respective PDCCH layer, wherein a first PDCCH layer corresponding to a first search space set or a first search space set group of the two search space sets or the two search space set groups is transmitted over a different polarization direction than a second PDCCH layer corresponding to a second search space set or a second search space set group of the two search space sets or the two search space set groups.

9. The device of claim 6, wherein the performing the blind detection comprises:
performing the blind detection on one search space set or one search space set group on one PDCCH layer, wherein the one PDCCH layer is associated with one DMRS port or is transmitted over a single polarization direction.

10. The device of claim 6, wherein the performing the blind detection comprises:
performing the blind detection on one search space set or one search space set group on one PDCCH layer, wherein the PDCCH layer is associated with a plurality of DMRS ports or is transmitted over a plurality of polarization directions.

11. A method comprising:
transmitting an indication of an association between at least one physical downlink control channel (PDCCH) layer and at least one demodulation reference signal (DMRS) port from more than one available DMRS port, wherein each PDCCH layer of the at least one PDCCH layer comprises one or more search space sets or one or more search space set groups, and each DMRS port of the at least one DMRS port is transmitted over one polarization direction.

12. The method of claim 11, wherein the indication indicates that two search space sets or two search space set groups are each on a respective PDCCH layer, wherein each PDCCH layer is associated with one DMRS port.

13. The method of claim 11, wherein the indication indicates that two search space sets or two search space set groups are each on a respective PDCCH layer, wherein a first PDCCH layer corresponding to a first search space set or a first search space set group of the two search space sets or the two search space set groups is transmitted over a different polarization direction than a second PDCCH layer corresponding to a second search space set or a second search space set group of the two search space sets or the two search space set groups.

14. The method of claim 11, wherein the indication indicates that one search space set or one search space set group is on one PDCCH layer, wherein the one PDCCH layer is associated with one DMRS port or is transmitted over a single polarization direction.

15. The method of claim 11, wherein the indication indicates that one search space set or one search space set group is on one PDCCH layer, wherein the PDCCH layer is associated with a plurality of DMRS ports or is transmitted over a plurality of polarization directions.

16. A device comprising:
one or more processors, when executing program instructions stored in the device, cause the device to perform:
transmitting an indication of an association between at least one physical downlink control channel (PDCCH) layer and at least one demodulation reference signal (DMRS) port from more than one available DMRS port, wherein each PDCCH layer of the at least one PDCCH layer comprises one or more search space sets or one or more search space set groups, and each DMRS port of the at least one DMRS port is transmitted over one polarization direction.

17. The device of claim 16, wherein the indication indicates that two search space sets or two search space set groups are each on a respective PDCCH layer, wherein each PDCCH layer is associated with one DMRS port.

18. The device of claim 16, wherein the indication indicates that two search space sets or two search space set groups are each on a respective PDCCH layer, wherein a first PDCCH layer corresponding to a first search space set or a first search space set group of the two search space sets or the two search space set groups is transmitted over a different polarization direction than a second PDCCH layer corresponding to a second search space set or a second search space set group of the two search space sets or the two search space set groups.

19. The device of claim 16, wherein the indication indicates that one search space set or one search space set group is on one PDCCH layer, wherein the one PDCCH layer is associated with one DMRS port or is transmitted over a single polarization direction.

20. The device of claim 16, wherein the indication indicates that one search space set or one search space set group is on one PDCCH layer, wherein the PDCCH layer is associated with a plurality of DMRS ports or is transmitted over a plurality of polarization directions.
